(19) United States
(12) Patent Application Publication
(10) Pub. No.: US 2016/0054567 A1
(43) Pub. Date: Feb. 25, 2016

(54) MOBILE TERMINAL, GLASSES-TYPE TERMINAL, AND MUTUAL INTERWORKING METHOD USING SCREENS THEREOF

(71) Applicant: LG ELECTRONICS INC., Seoul (KR)

(72) Inventors: Mina KIM, Seoul (KR); Keansub LEE, Seoul (KR); Hosung SONG, Seoul (KR)

(73) Assignee: LG ELECTRONICS INC., Seoul (KR)

(21) Appl. No.: 14/829,480

(22) Filed: Aug. 18, 2015

(30) Foreign Application Priority Data
Aug. 19, 2014 (KR) 10-2014-0107931

(51) Int. Cl. G02B 27/01; G06F 3/0488; G06T 19/00; G06F 21/62; H04N 7/18; G06K 9/46; G06F 3/0482; H04L 29/06

(52) U.S. Cl. CPC G02B 27/0172; G06F 3/0482; G06F 3/0488; H04L 65/403; G06F 21/6245; H04N 7/18; G06K 9/46; G06T 19/006; G02B 2027/0178; G06K 2009/4666

(57) ABSTRACT

Disclosed are a mobile terminal, a glasses-type terminal, and a mutual interworking method through sharing of screens thereof. The mobile terminal includes: a memory configured to store therein a setting for a screen sharing mode; a display unit configured to display a terminal screen; and a controller configured to execute content sharing by changing the terminal screen according to a function being executed on a glass screen, if the terminal screen and the glass screen are overlapped with each other, after the terminal screen enters a camera region of the glass terminal.

### CROSS-REFERENCE TO RELATED APPLICATION

Pursuant to 35 U.S.C. §119(a), this application claims the benefit of earlier filing date and right of priority to Korean Patent Application No. 10-2014-0107931, filed on Aug. 19, 2014, the contents of which are hereby incorporated by reference herein in its entirety.

### BACKGROUND OF THE INVENTION

1. Field of the Invention

The present invention relates to a mobile terminal, a glasses-type terminal, and a mutual interworking method through sharing of screens thereof.

2. Background of the Invention

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

Efforts are ongoing to support and increase the functionality of mobile terminals. Such efforts include software and hardware improvements, as well as changes and improvements in the structural components.

Recently, a wearable device such as a smart watch and a glasses-type terminal provides various types of services solely or by interworking with the mobile terminal. That is, the glasses-type terminal has therein a camera function, a video function, and a microphone function, and can be interworked with a smart phone or other communicable device by mounting a WiFi function and a Bluetooth function therein. Thus, the glasses-type terminal is not a mere video player, but is a wearable smart device which serves as a mobile terminal in the form of glasses.

Generally, a screen of the glasses-type terminal (glass screen) is controlled through a voice input, and by touching a temple of the glasses-type terminal.

However, the screen control method through a voice input is not effective when noise occurs nearby. Further, the screen control method by touching a temple of the glasses-type terminal is not familiar to a user, and has a difficulty in copying, deleting, moving and transferring content displayed on the screen. Further, in case of viewing the screen of the glasses-type terminal for a long time, a user's eye fatigue increases.

Accordingly, for a service using a wearable device such as a glasses-type terminal, only a limited screen control method is used. Various user interfaces (UIs) and user experiences (UXs) have not been developed yet.

Thus, it is required to interwork a glasses-type terminal with a mobile terminal which provides various screen control methods, or various types of devices, in a visual manner.

### SUMMARY OF THE INVENTION

Therefore, an aspect of the detailed description is to provide a mobile terminal which can provide various interworking methods in a visual manner, a glasses-type terminal, and a mutual interworking method through sharing of screens thereof.

Another aspect of the detailed description is to provide a mobile terminal which can control screens by simultaneously using its screen and a screen of a glasses-type terminal, a glasses-type terminal, and a mutual interworking method through sharing of screens thereof.

Anther aspect of the detailed description is to provide a mobile terminal which can protect a user's privacy thereon by using a glasses-type terminal, a glasses-type terminal, and a mutual interworking method through sharing of screens thereof.

To achieve these and other advantages and in accordance with the purpose of this specification, as embodied and broadly described herein, there is provided a method for sharing information between a mobile terminal and a glass terminal, the method including: checking whether a screen sharing mode has been set or not, if a screen of the mobile terminal is captured within a camera region of the glass terminal; determining a type of the set screen sharing mode; sensing an overlapped state between a screen of the mobile terminal and a screen of the glass terminal, if the screen sharing mode is a type to use both the terminal screen and the glass screen; and if the two screens are overlapped with each other, executing content sharing by changing the terminal screen, according to a function being executed on the glass screen.

To achieve these and other advantages and in accordance with the purpose of this specification, as embodied and broadly described herein, there is also provided a mobile terminal, including: a memory configured to store therein a setting for a screen sharing mode; a display unit configured to display a terminal screen; and a controller configured to execute content sharing by changing the terminal screen according to a function being executed on a glass screen, if the terminal screen and the glass screen are overlapped with each other, after the terminal screen enters a camera region of the glass terminal.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1A is a block diagram illustrating a mobile terminal according to the present invention;

FIGS. 1B and 1C are conceptual views of a mobile terminal according to the present invention, which are viewed from different directions;

FIG. 2 is a perspective view illustrating one example of a glass-type mobile terminal 200 according to another exemplary embodiment;

FIG. 3 is a configuration view illustrating a terminal screen and a glass screen which are included in a camera region;

FIG. 4 is a view illustrating an example to set a screen sharing mode according to an embodiment of the present invention;

FIGS. 5A and 5B are configuration views of screens according to a screen sharing type;

FIG. 6 is a flowchart illustrating an information sharing method between a mobile terminal and a glasses-type terminal (glass terminal) according to an embodiment of the present invention;

FIG. 7 is a flowchart illustrating content sharing between a mobile terminal and a glass terminal in a screen sharing mode according to a first screen sharing type;

FIGS. 8A to 8C are views illustrating a content sharing method between a mobile terminal and a glass terminal in a screen sharing mode according to a first screen sharing type;

FIG. 9 is a flowchart illustrating content sharing between a mobile terminal and a glass terminal in a screen sharing mode according to a second screen sharing type;

FIGS. 10 and 11 are views illustrating an example of a content sharing method between a mobile terminal and a glass terminal by screen overlapping, in a screen sharing mode according to a second screen sharing type;

FIG. 12 is a view illustrating an embodiment to control capturing by a glass terminal, using a mobile terminal, in a screen overlapped state;

FIGS. 13A to 13C are views illustrating an information sharing method between a mobile terminal and a glass terminal using screen overlapping;

FIGS. 14A to 14D are views illustrating an embodiment to check an image captured to be uploaded by a glass terminal, by screen overlapping;

FIG. 15 is a view illustrating an embodiment to update a photo uploaded to an SNS by a glass terminal, through interworking with a gallery of a mobile terminal;

FIG. 16 is a view illustrating an embodiment to update a photo uploaded to an SNS by a glass terminal, by screen overlapping;

FIG. 17 is a view illustrating an embodiment to share content between a terminal screen and a glass screen by touch, in a screen sharing mode according to a second screen sharing;

FIG. 18 is a view illustrating a first embodiment to transmit a photo displayed on a glass screen, to a mobile terminal, by touch in a screen sharing mode according to a second screen sharing;

FIG. 19 is a view illustrating a embodiment to perform an interworking between the mobile terminal and the glass terminal by touch in a screen sharing mode according to a second screen sharing.

FIG. 20 is a view illustrating an embodiment to control transparency of a glass screen during screen overlapping, in a screen sharing mode according to a second screen sharing;

FIG. 21 is a view illustrating a method for protecting a user's privacy in a screen sharing mode according to the present invention;

FIGS. 22A and 22B are views illustrating an embodiment to search for information in a screen sharing mode according to the present invention;

FIG. 23 is a view illustrating an embodiment to release a locked state in a screen sharing mode according to the present invention; and

FIG. 24 is a view illustrating an embodiment to release a locked state of content in a screen sharing mode according to the present invention.

### DETAILED DESCRIPTION OF THE INVENTION

Description will now be given in detail according to the exemplary embodiments, with reference to the accompanying drawings. For the sake of brief description with reference to the drawings, the same or equivalent components will be provided with the same reference numbers, and description thereof will not be repeated. A suffix “module” or “unit” used for constituent elements disclosed in the following description is merely intended for easy description of the specification, and the suffix itself does not give any special meaning or function. In describing the present invention, if a detailed explanation for a related known function or construction is considered to unnecessarily divert the gist of the present disclosure, such explanation has been omitted but would be understood by those skilled in the art. The accompanying drawings are used to help easily understood the technical idea of the present invention and it should be understood that the idea of the present disclosure is not limited by the accompanying drawings.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers and a digital signage.

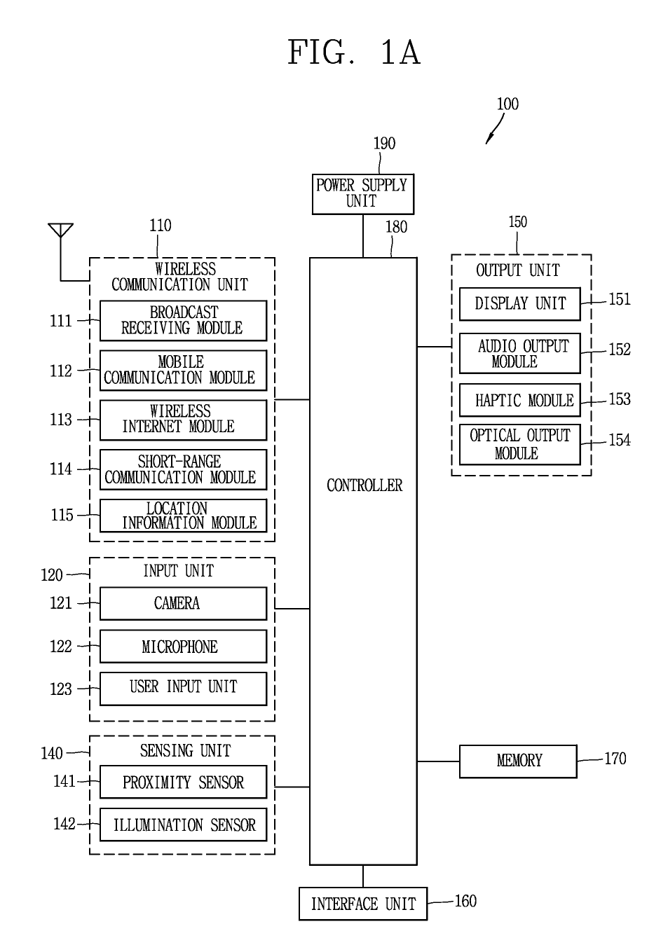

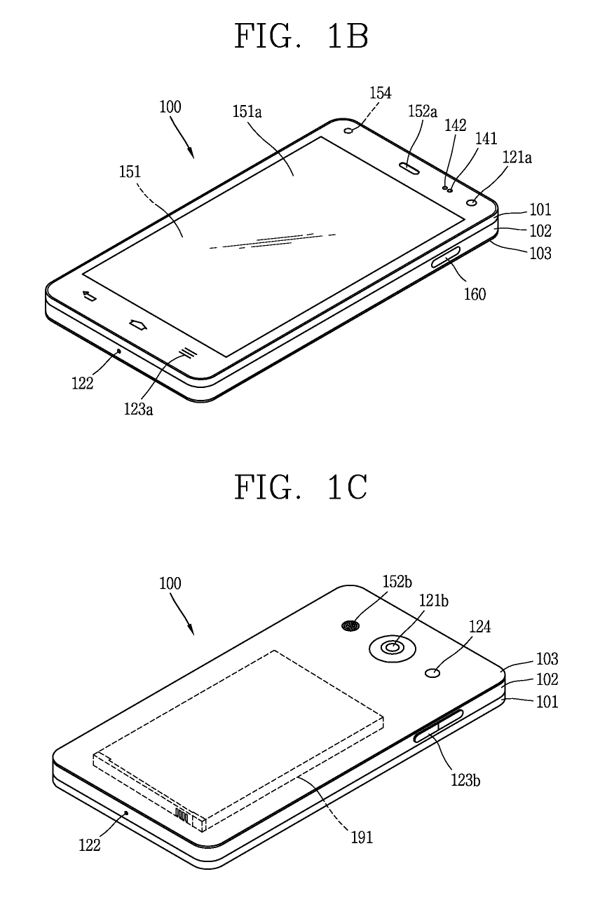

FIG. 1A is a block diagram illustrating a mobile terminal according to the present invention, and FIGS. 1B and 1C are conceptual views of a mobile terminal according to the present invention, which are viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring now to FIG. 1, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1, the sensing unit 140 is shown having a proximity sensor 141 and an illumination sensor 142. If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154.

The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions corresponding to a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations corresponding to the application programs. The controller 180 may provide or process information or functions appropriate for a user by processing signals, data, information and the like, which are input or output by the aforementioned various components, or activating application programs stored in the memory 170.

Further, the controller 180 may control at least one of the aforementioned components in FIG. 1, so as to drive the application programs stored in the memory 170. Also, the controller 180 may operate at least two of the components of the mobile terminal 100 in a combined manner.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least some of the above components may operate in a cooperating manner, so as to implement an operation or a control method of a mobile terminal according to various embodiments to be explained later. The operation or the control method of the mobile terminal may be implemented on the mobile terminal by driving at least one application program stored in the memory 170.

Referring still to FIG. 1A, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000(Code Division Multi Access 2000), Wideband CDMA (WCDMA), High Speed Downlink Packet access (HSDPA), Long Term Evolution (LTE), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), Long Term Evolution (LTE), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, GSM, CDMA, WCDMA, LTE and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal. As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation corresponding to an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing corresponding to voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

FIGS. 1B and 1C depict certain components as arranged on the mobile terminal. However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIGS. 1B and 1C illustrate the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject.

As shown in FIG. 1C, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

The power supply unit 190 (refer to FIG. 1A) for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

In accordance with still further embodiments, a mobile terminal may be configured as a device which is wearable on a human body. Such devices go beyond the usual technique of a user grasping the mobile terminal using their hand. Examples of the wearable device include a smart watch, a smart glass, a head mounted display (HMD), and the like.

A typical wearable device can exchange data with (or cooperate with) another mobile terminal 100. In such a device, the wearable device generally has functionality that is less than the cooperating mobile terminal. For instance, the short-range communication module 114 of a mobile terminal 100 may sense or recognize a wearable device that is near-enough to communicate with the mobile terminal. In addition, when the sensed wearable device is a device which is authenticated to communicate with the mobile terminal 100, the controller 180 may transmit data processed in the mobile terminal 100 to the wearable device via the short-range communication module 114, for example. Hence, a user of the wearable device can use the data processed in the mobile terminal 100 on the wearable device. For example, when a call is received in the mobile terminal 100, the user can answer the call using the wearable device. Also, when a message is received in the mobile terminal 100, the user can check the received message using the wearable device.

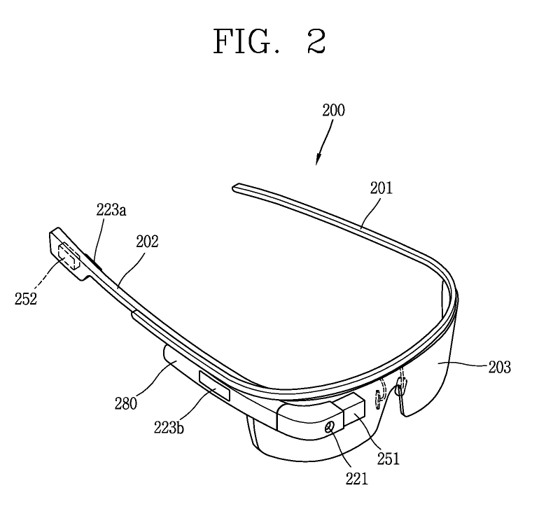

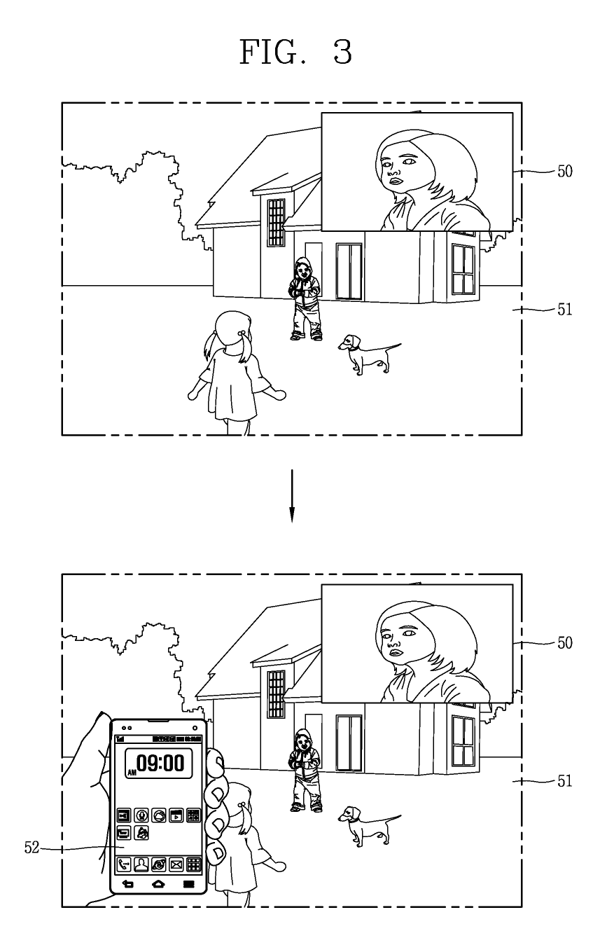

FIG. 2 is a perspective view illustrating one example of a glass-type mobile terminal 200 according to another exemplary embodiment.

The glass-type mobile terminal 200 can be wearable on a head of a human body and provided with a frame (case, housing, etc.) therefor. The frame may be made of a flexible material to be easily worn. The frame of mobile terminal 200 is shown having a first frame 201 and a second frame 202, which can be made of the same or different materials.

The frame may be supported on the head and defines a space for mounting various components. As illustrated, electronic components, such as a control module 280, an audio output module 252, and the like, may be mounted to the frame part. Also, a lens 203 for covering either or both of the left and right eyes may be detachably coupled to the frame part.

The control module 280 controls various electronic components disposed in the mobile terminal 200. The control module 280 may be understood as a component corresponding to the aforementioned controller 180. FIG. 2 illustrates that the control module 280 is installed in the frame on one side of the head, but other locations are possible.

The display unit 251 may be implemented as a head mounted display (HMD). The HMD refers to display techniques by which a display is mounted to a head to show an image directly in front of a user's eyes. In order to provide an image directly in front of the user's eyes when the user wears the glass-type mobile terminal 200, the display unit 251 may be located to correspond to either or both of the left and right eyes. FIG. 2 illustrates that the display unit 251 is located on a portion corresponding to the right eye to output an image viewable by the user's right eye.

The display unit 251 may project an image into the user's eye using a prism. Also, the prism may be formed from optically transparent material such that the user can view both the projected image and a general visual field (a range that the user views through the eyes) in front of the user.

In such a manner, the image output through the display unit 251 may be viewed while overlapping with the general visual field. The mobile terminal 200 may provide an augmented reality (AR) by overlaying a virtual image on a realistic image or background using the display.

The camera 221 may be located adjacent to either or both of the left and right eyes to capture an image. Since the camera 221 is located adjacent to the eye, the camera 221 can acquire a scene that the user is currently viewing.

The camera 221 is provided at a control module 280. However, the present invention is not limited to this. The camera 221 may be provided at the frame part. In some embodiments, multiple cameras 221 may be utilized. Such multiple cameras 221 may be used to acquire a stereoscopic image.

The glass-type mobile terminal 200 may include user input units 223a and 223b, which can each be manipulated by the user to provide an input. The user input units 223a and 223b may employ techniques which permit input via a tactile input. Typical tactile inputs include a touch, push, or the like. The user input units 223a and 223b are shown operable in a pushing manner and a touching manner as they are located on the frame and the control module 280, respectively.

If desired, mobile terminal 200 may include a microphone which processes input sound into electric audio data, and an audio output module 252 for outputting audio. The audio output module 252 may be configured to produce audio in a general audio output manner or an osteoconductive manner. When the audio output module 252 is implemented in the osteoconductive manner, the audio output module 252 may be closely adhered to the head when the user wears the mobile terminal 200 and vibrate the user's skull to transfer sounds.

The present invention proposes various interworking methods between a mobile terminal and a glasses-type terminal (hereinafter, will be referred to as a glass terminal), through sharing of screens of the mobile terminal and the glass terminal. For the screen sharing, the mobile terminal and the glass terminal should be paired with each other.

Configuration of Basic Screen

FIG. 3 is a configuration view illustrating a terminal screen and a glass screen which are included in a camera region.

Once a user wears a glass terminal, a glass screen 50 may be displayed. A camera preview, a captured image, and various types of content may be displayed on the glass screen 50. In this state, if a mobile terminal enters a region 51 captured by a camera of the glass terminal (hereinafter, will be referred to as a glass camera) (“camera region”), both the glass screen 50 and a terminal screen 52 are located within the camera region 51.

Screen Sharing Mode

A screen sharing mode indicates a mode for sharing a terminal screen and a glass screen. More specifically, the screen sharing mode indicates a mode for controlling an operation of a glass terminal using a terminal screen, and for easily transferring content.

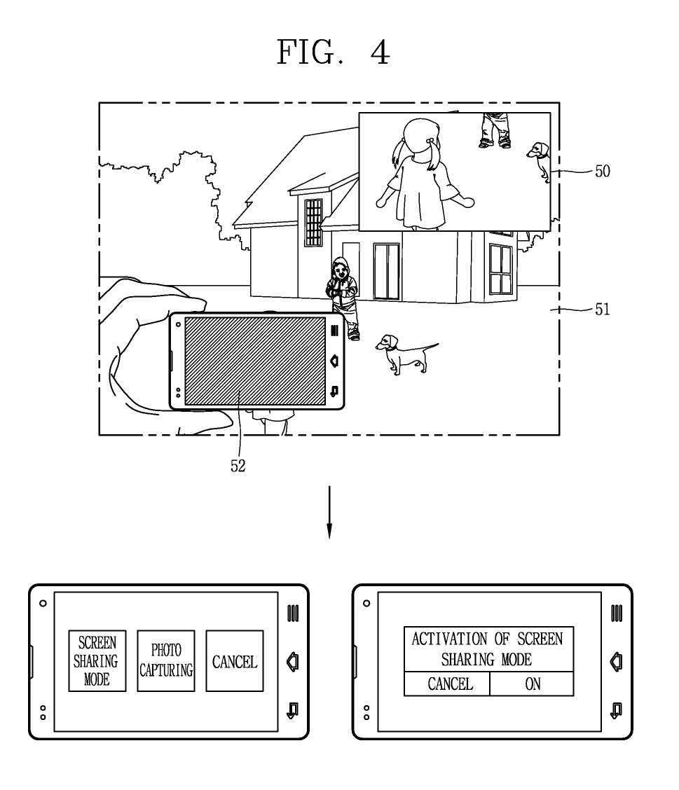

FIG. 4 is a view illustrating an example to set a screen sharing mode according to an embodiment of the present invention.

As shown in FIG. 4, once the terminal screen 52 is firstly recognized on the camera region 51, the controller 180 of the mobile terminal may display a pop-up inquiring whether to execute screen sharing or not.

The pop-up is displayed only when more than a predetermined size of the terminal screen 52 is recognized within the camera region 51, through analysis of a preview image of the glass camera. A signal, indicating that the terminal screen has been recognized, is transmitted to the controller 180 of the mobile terminal. The pop-up includes a message or menu for turning on/off a screen sharing function. FIG. 4 illustrates a pop-up including menus. A user may set a screen sharing mode by touching a screen sharing mode on the pop-up, or through a voice input.

The controller 180 may display an additional pop-up inquiring whether to activate the set screen sharing mode or not.

Alternatively, the screen sharing mode may be set initially on a user's explanation menu. The set screen sharing mode is stored in the memory 170.

In the present invention, a ‘screen sharing type’ may be selected from a pop-up or a user's menu, when a screen sharing mode is set. The screen sharing type may be largely classified into a first screen sharing type using only a terminal screen, and a second screen sharing type using both a terminal screen and a glass screen.

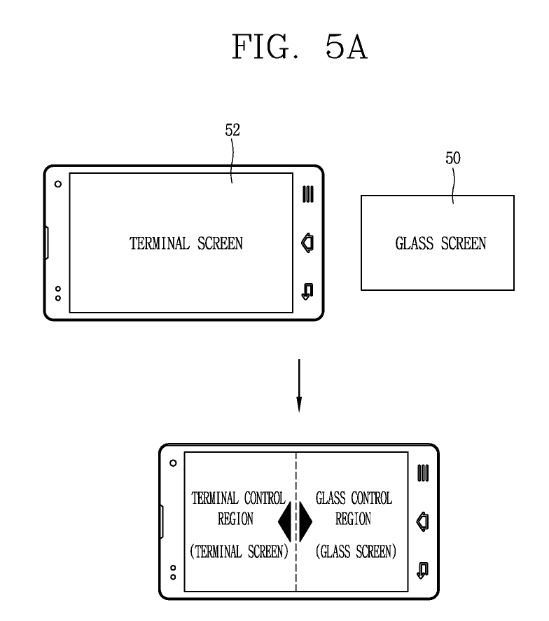

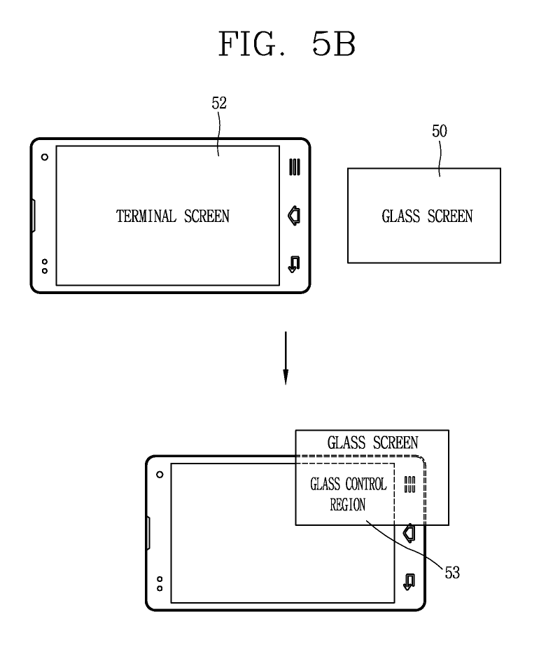

FIGS. 5A and 5B are configuration views of screens according to a screen sharing type.

FIG. 5A is a view illustrating a screen configuration according to a first screen sharing. Once a first screen sharing is set, the controller 180 of the mobile terminal divides a screen of the mobile terminal (terminal screen) into a terminal (screen) control region and a glass (screen) control region. Then, the controller 180 displays the terminal screen 52 on the terminal control region, and displays the glass screen 50 on the glass control region. In this case, a display of the glass terminal is turned off. A size of the glass control region may be controlled.

In an embodiment, the size of the glass control region may be controlled by controlling a division ratio of the terminal screen, by dragging an indicator provided at a central region right and left.

In another embodiment, the size of the glass control region may be controlled by a double touch applied to the glass control region. For instance, once the glass control region is double-touched, the glass control region is increased to an entire screen of the mobile terminal. On the other hand, when the glass control region is double-touched again, the glass control region is reduced to the original screen.

FIG. 5B is a view illustrating a screen configuration according to a second screen sharing.

As shown in FIG. 5B, in a second screen sharing method, since both the terminal screen and the glass screen are used, a region where the glass screen and the terminal screen are overlapped with each other is recognized as the glass control region 53. Thus, if the glass screen is overlapped with the terminal screen in an activated state of the terminal screen and the glass screen, a user may execute a content transfer function and a content edition function, using the overlapped region, i.e., the glass control region 53. For instance, if a user stares at the same region of the terminal screen for more than 3 seconds, the region is automatically set as the glass control region 53. Thereafter, even if the glass terminal is moved even slightly, the content transfer function and the content edition function may be controlled within the set region.

Screen overlapping by the second screen sharing method includes a method for overlapping two screens each other by moving the terminal screen to the glass screen in a state where a user has worn the glass terminal, and a method for overlapping two screens each other by a user's staring at the terminal screen.

Hereinafter, an information sharing method between the mobile terminal and the glass terminal based on a screen sharing type in a screen sharing mode will be explained in more detail. In all embodiments to be explained later, the mobile terminal and the glass terminal are paired with each other.

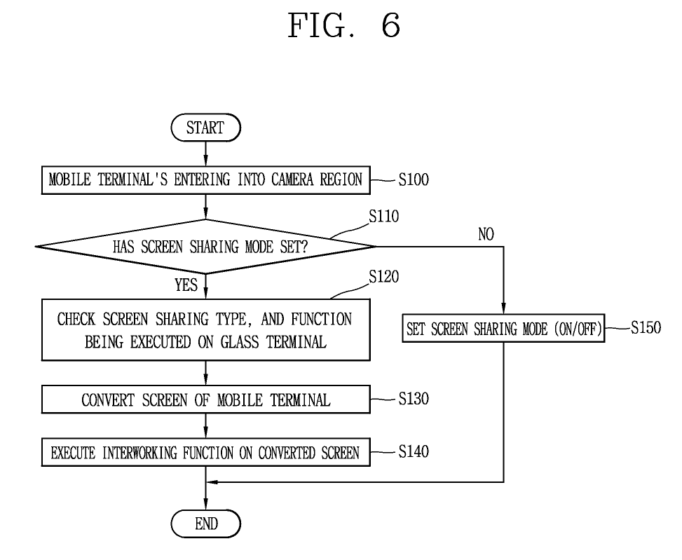

FIG. 6 is a flowchart illustrating an information sharing method between the mobile terminal and the glass terminal according to an embodiment of the present invention.

As shown in FIG. 6, upon recognition of the terminal screen's entering into the camera region (S100), the controller 180 checks whether a screen sharing mode has been set or not (S110). If the screen sharing mode has been set as a check result, the controller 180 checks a screen sharing type and a function executed in the glass terminal, converts the terminal screen, and then executes an interworking function (S120˜140).

The function executed in the glass terminal may include a function to display a photo captured by a camera on the glass screen in the form of a preview, a function to transmit a photo captured by the camera to a cloud, and a function to display a photo captured by the camera to the mobile terminal.

On the other hand, if the screen sharing mode has not been set as a check result, the controller 180 provides a pop-up for setting a screen sharing mode (S150), such that a user sets the screen sharing mode.

Screen Sharing Mode According to First Screen Sharing

In a screen sharing mode according to a first screen sharing, the glass screen disappears, and only the terminal screen is used. That is, transmitting content to an SNS, transmitting content to a cloud, activating an edition button, and executing a required function are implemented on the terminal screen. Especially, in case of transmitting a photo to other user, the photo is dragged to an address book on the terminal screen so that the photo on the glass screen is transmitted to the other user. The controller 180 may display a photo transmitted to an SNS, a photo transmitted to a cloud, a photo transmitted to other user, and a photo transmitted to a mobile terminal, in a differentiated manner.

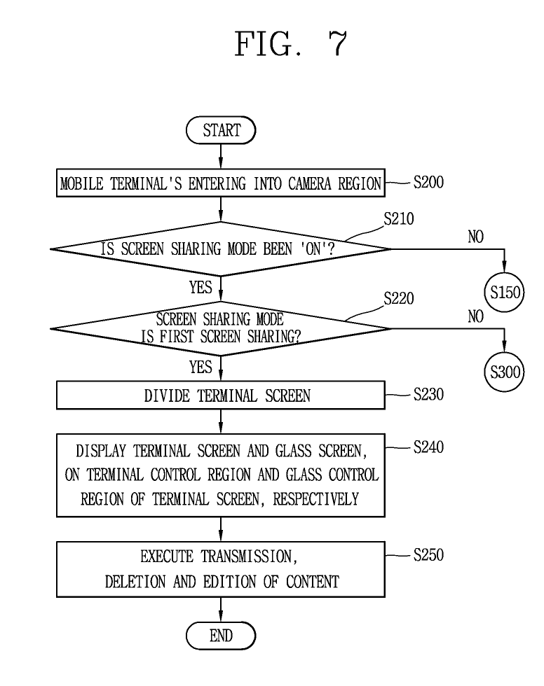

FIG. 7 is a flowchart illustrating content sharing between the mobile terminal and the glass terminal in a screen sharing mode according to a first screen sharing type.

As shown in FIG. 7, upon recognition of a gallery displayed on the terminal screen within the camera region by more than a predetermined size, the controller 180 of the mobile terminal checks whether a screen sharing mode has been set or not (S200, S210). If the screen sharing mode has not been set as a check result, the controller 180 executes the aforementioned step (S150). On the other hand, if the screen sharing mode has been set as a check result, the controller 180 determines a screen sharing type (S220).

If the set screen sharing mode is a first screen sharing as a determination result, the controller 180 divides the terminal screen into a terminal control region and a glass control region (S230), and displays the terminal screen on the terminal control region and displays the glass screen on the glass control region (S240). On the other hand, if the set screen sharing mode is a second screen sharing, the controller 180 executes a step (S300) to be explained later.

A user executes transmission, deletion and edition of content by a user's drag and touch on the terminal control region or the glass control region (S250).

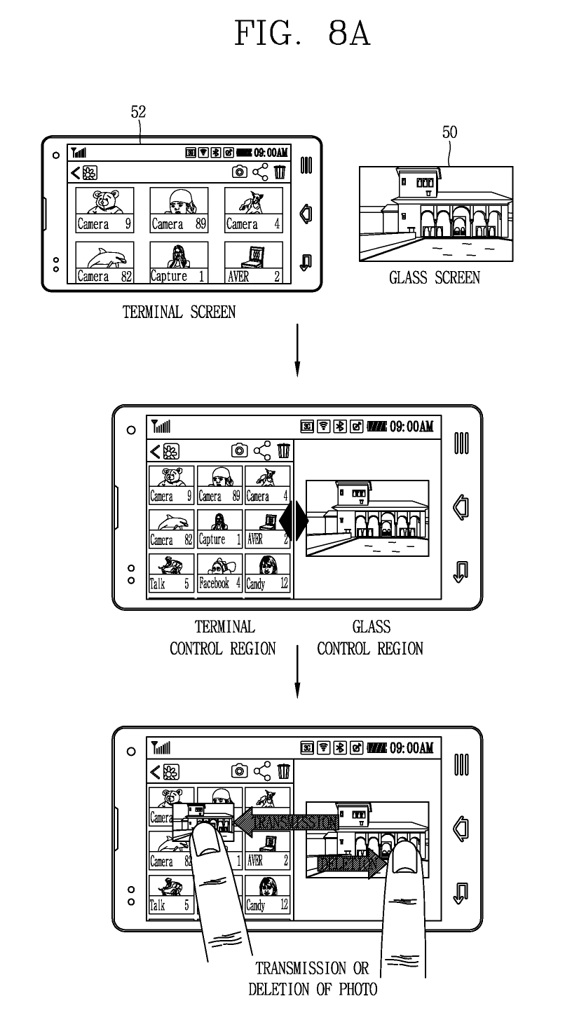

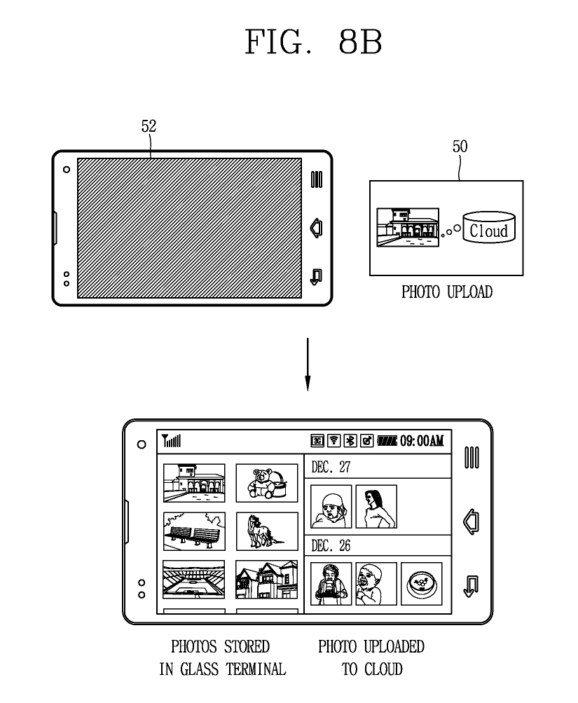

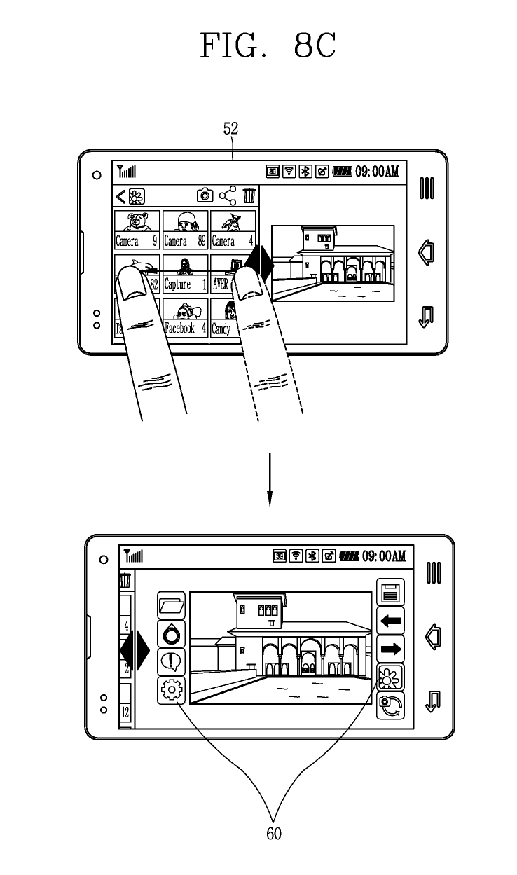

FIGS. 8A to 8C are views illustrating an example of a content sharing method between the mobile terminal and the glass terminal in a screen sharing mode according to a first screen sharing type.

As shown in FIG. 8A, a photo captured by the glass camera may be displayed on the glass screen in the form of a preview. Once a gallery displayed on the terminal screen is recognized within the camera region by more than a predetermined size, the controller 180 of the mobile terminal determines a screen sharing type.

If it is determined that a screen sharing type is a first screen sharing, the controller divides the terminal screen into a terminal control region and a glass control region, and displays a gallery on the terminal control region and displays a subject image on the glass control region. The display of the glass terminal is turned off, and an icon for deletion, transmission, etc. of content may be activated on the glass control region.

A user controls each of the terminal control region and the glass control region, in a drag and touch manner. That is, a user may send a photo from the glass terminal to the mobile terminal by dragging the photo displayed on the glass screen into the gallery of the terminal screen. Alternatively, a user may select a deletion menu from the terminal control region or the glass control region, or may delete a photo by dragging the photo to a region out of the glass control region.

FIG. 8B illustrates a content sharing method when a photo captured by the glass terminal is being sent to a cloud.

As shown in FIG. 8B, a user may upload a photo captured by the glass terminal to a cloud, and an icon indicating that the photo is being uploaded to the cloud may be displayed on the glass screen.

In this state, upon recognition of the terminal screen within the camera region by more than a predetermined size, the controller 180 of the mobile terminal displays photos stored in the glass terminal on the terminal control region, and displays photos uploaded to a cloud on the glass control region. If the mobile terminal is in an off state, the controller 180 may activate the terminal screen. If a screen sharing mode of the mobile terminal has been set to be an off state, the controller 180 may display a pop-up inquiring whether to activate the screen sharing mode.

The controller 180 displays photos stored in the glass terminal on the terminal control region, such that photos uploaded to a cloud and photos not uploaded to the cloud are differentiated from each other. For instance, the controller 180 displays photos uploaded to the cloud in a semi-transparent manner, and displays photos not uploaded to the cloud clearly on an upper part.

A photo captured by the glass terminal may be sent to the mobile terminal. The photo being sent may be displayed on the glass screen. In this case, photos not sent to the mobile terminal, among photos stored in the glass terminal, are displayed on an upper part clearly. On the contrary, photos sent already are displayed on a lower part in a semi-transparent manner. Likewise, photos sent from the glass terminal, among photos stored in the gallery, are displayed on an upper part of the terminal control region clearly. On the other hand, the remaining photos are displayed on a lower part of the terminal control region in a semi-transparent manner.

FIG. 8C is a view illustrating an example to control a size of the glass control region.

As shown in FIG. 8C, if an indicator (e.g., arrow) disposed between the glass control region and the terminal control region is moved to the left, or if the glass control region is double-touched, the controller 180 displays a photo by enlarging the glass control region to an entire screen, and activates a photo edition tool 60 for editing photos.

Screen Sharing Mode According to Second Screen Sharing

A screen sharing mode according to a second screen sharing indicates a mode using a terminal screen and a glass screen. In the screen sharing mode, various types of control operations are executed by screen overlapping. A control operation by screen overlapping is determined based on a state of the glass screen.

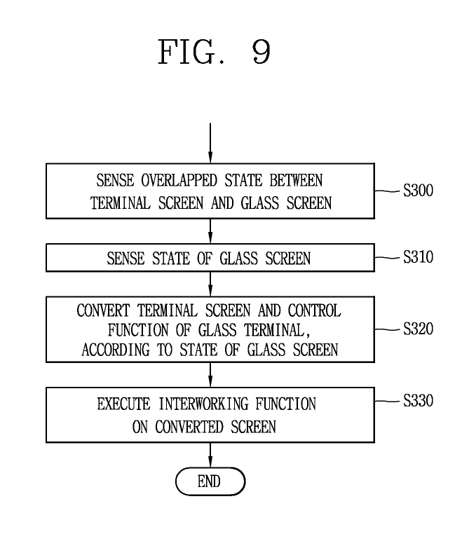

FIG. 9 is a flowchart illustrating content sharing between the mobile terminal and the glass terminal in a screen sharing mode according to a second screen sharing type.

Upon recognition of a gallery displayed on the terminal screen within the camera region by more than a predetermined size, the controller 180 of the mobile terminal checks whether a screen sharing mode has been set or not. If the screen sharing mode has not been set as a check result, the controller 180 executes the aforementioned step (S150). On the other hand, if the screen sharing mode has been set as a check result, the controller 180 determines a screen sharing type.

If the set screen sharing mode is a first screen sharing as a determination result, the controller 180 executes the steps of FIG. 7 (S220˜S250). On the other hand, if the set screen sharing mode is a second screen sharing as a determination result, the controller 180 senses overlapping between the terminal screen and the glass screen. Upon occurrence of screen overlapping, the controller 180 converts the terminal screen or controls a function of the glass terminal (volume, brightness, etc.) by sensing a state of the glass screen (S310, S320). Further, the controller 180 executes transmission, deletion, etc. of content between the mobile terminal and the glass terminal, based on a user's touch input or a user's gesture applied to the converted screen (S330).

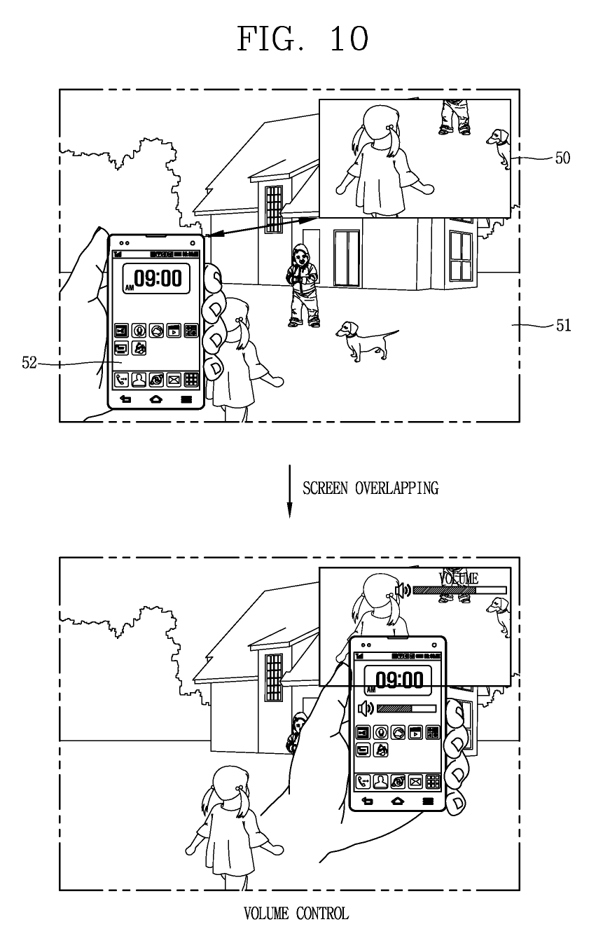

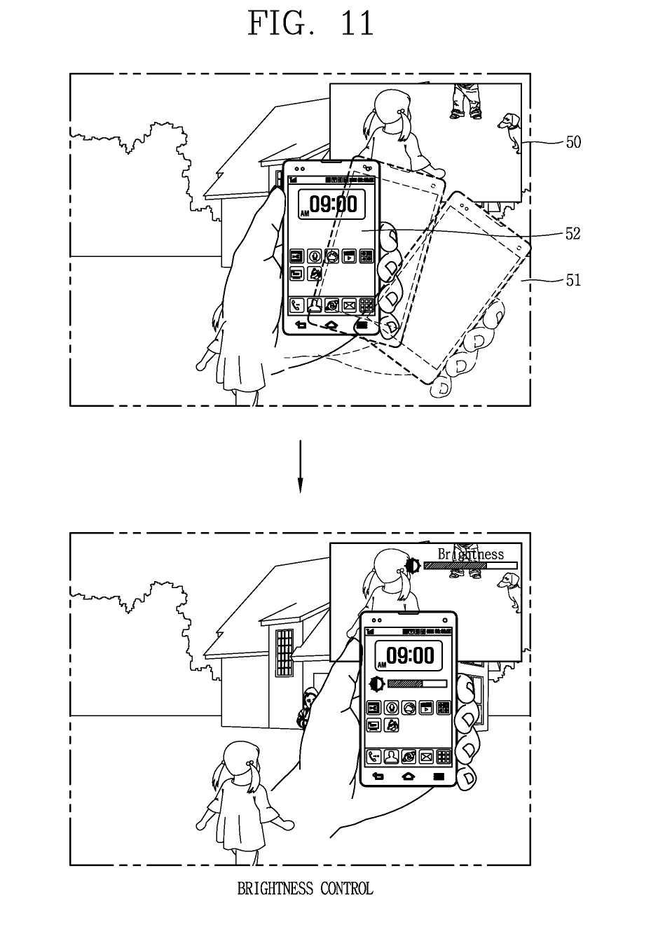

FIGS. 10 and 11 are views illustrating an example of a content sharing method between the mobile terminal and the glass terminal by screen overlapping, in a screen sharing mode according to a second screen sharing type. The screen overlapping in FIGS. 10 and 11 means screen overlapping between the glass screen which is in a standby state and the terminal screen.

Overlapping Between the Terminal Screen and the Glass Screen which is in a Standby State

Generally, it is very inconvenient to change a setting value (e.g., volume, brightness, etc.) of a wearable device such as a glass terminal, since the wearable device has a very small screen. Such an inconvenience may be solved as the setting value of the glass terminal is changed by the mobile terminal. However, in this case, a setting menu with respect to the mobile terminal, and a setting menu with respect to the glass terminal should be implemented separately.

In the present invention, an input method to each device may be variable according to whether a preview screen of the glass camera and the terminal screen have been overlapped or not, and according to an overlapping method.

As shown in FIG. 10, if the glass screen 50 and the terminal screen 52 are overlapped with each other in a state where a screen sharing mode according to a second screen sharing has been set, a user may control a volume of the glass terminal using an up/down key of the mobile terminal. In this case, an indicator showing a volume control state is displayed on the glass screen 50.

If the user moves the mobile terminal right and left in the overlapped state between the glass screen 50 and the terminal screen 52, the controller 180 of the mobile terminal displays a setting menu on the terminal screen as shown in FIG. 11. If the user selects for a brightness from the setting menu the controller 180 displays a menu for controlling a brightness of the glass screen on the terminal screen. Thus, the user may control a screen brightness of the glass terminal using the up-down key of the mobile terminal.

In case of capturing a subject using the camera of the glass terminal, a user should input a voice such as “Take a picture”, or should execute a control application of the mobile terminal.

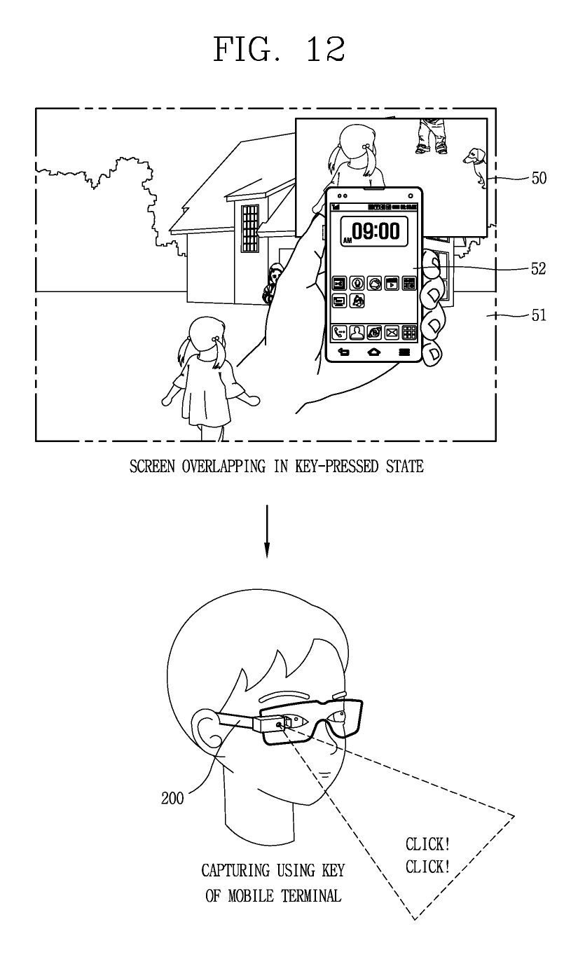

FIG. 12 is a view illustrating an embodiment to control capturing by the glass terminal, using the mobile terminal, in a screen overlapped state.

As shown in FIG. 12, if a user selects a capturing mode from the glass terminal, a camera preview is displayed on the glass screen 50. Then, if the user of the mobile terminal overlaps the terminal screen 52 with the glass screen 50 in a state where an H/W key of the mobile terminal has been pressed, the H/W key is automatically registered as a ‘capturing button’ of the glass camera.

Then, the user may conveniently execute a capturing operation using the glass camera, by pressing the H/W key registered as a capturing button, without inputting a voice command to the glass terminal, or without additionally selecting a control button on the terminal screen.

Overlapping Between the Glass Screen where a Predetermined Function is being Executed, and the Terminal Screen

Generally, it is difficult to execute a multi-tasking such as copy, deletion, transfer and movement of content on the glass terminal, while a single function (e.g., a call function) is being executed on the glass terminal. Further, when the glass terminal and the mobile terminal interact with each other, a user should undergo complicated menu selections. Thus, operations related to functions are separately executed in the mobile terminal and the glass terminal.

The present invention provides a method for executing a mutual interworking operation with respect to a predetermined function, by screen overlapping between the mobile terminal and the glass terminal.

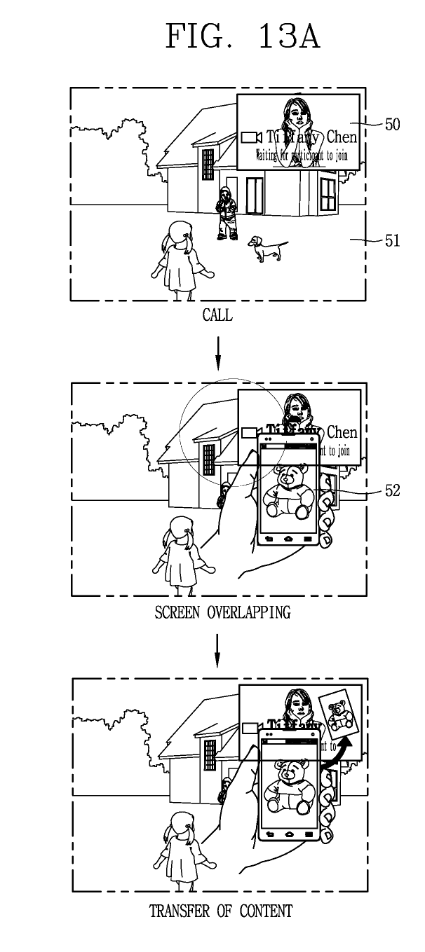

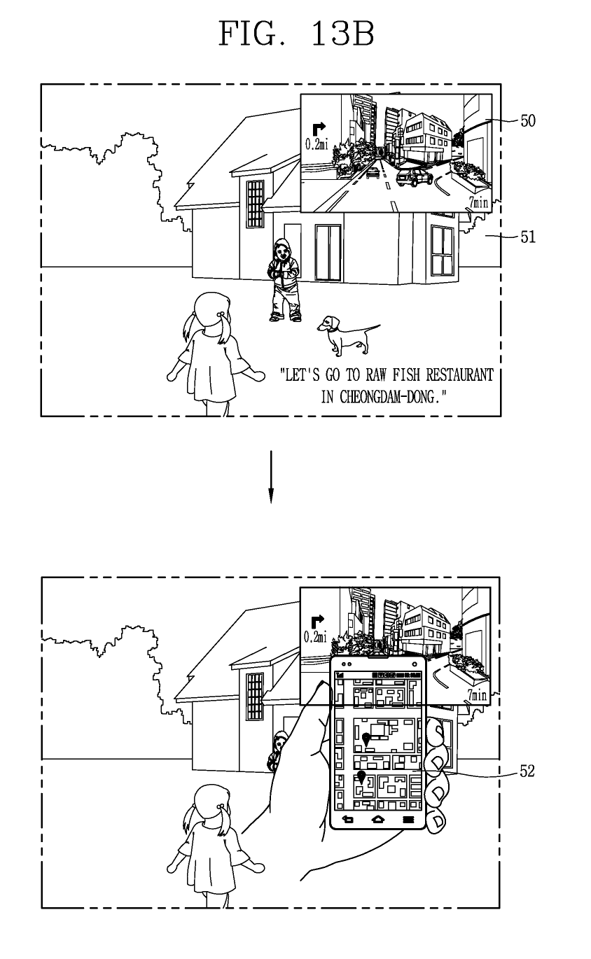

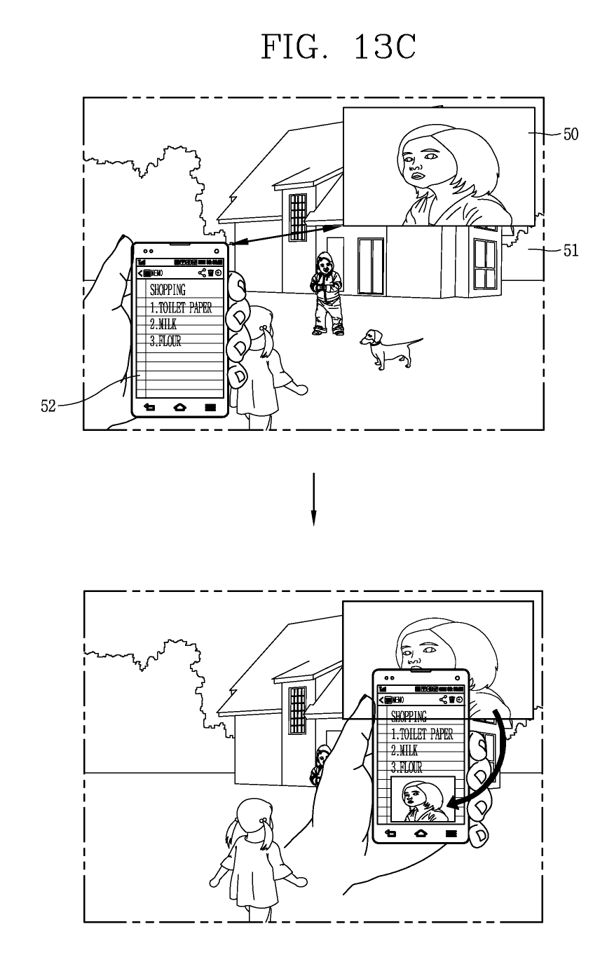

FIGS. 13A to 13C are views illustrating an information sharing method between the mobile terminal and the glass terminal using screen overlapping.

As shown in FIG. 13A, a user may execute a call function with other user (e.g., Tiffany Chen) using the glass terminal. While the call function is being executed, the user displays content or information to be shared with the glass terminal on the terminal screen, and overlaps the content or information with the glass screen. The content may include video and audio data such as photos, music files and video clips, and the information may include text information such as texts and web page phone numbers.

Once the terminal screen 52 and the glass screen 50 are overlapped with each other, a transmission direction of content is determined based on an overlapping time or a touch & drag direction. For instance, if the overlapping time is larger than a reference time, content is transferred from the mobile terminal to the glass terminal. On the other hand, if the overlapping time is smaller than the reference time, content is transferred from the glass terminal to the mobile terminal. Content transfer based on an overlapping time will be explained hereinafter, and content transfer based on a drag direction will be explained later. Content transfer based on an overlapping time or a touch & drag may be selected from a menu.

That is, if the two screens are overlapped with each other for a time longer than a reference time, content is transferred from the mobile terminal to the glass screen to thus be displayed in the form of a thumbnail, an icon, etc. The controller of the glass terminal feedbacks a completely received state of the content to a user, by changing a screen brightness, or by outputting a voice or vibrations.

A user may search/set a destination by displaying a navigation device on the glass terminal while driving a car. However, in a case where a new passing spot occurs or the destination is changed, the user has a difficulty in changing driving information using the glass terminal.

In that case, the user displays a new passing spot or a new destination on the terminal screen, in the form of an address, a map, a photo, etc. as shown in FIG. 13B. Then, the user overlaps the terminal screen with the glass screen. If the two screens are overlapped with each other for a time longer than a reference time, the new passing spot or the new destination displayed on the terminal screen is transferred to the glass terminal in the form of an address, a map, a photo, etc. As a result, the driving information is automatically changed. The changed driving information may be displayed on the glass screen.

As shown in FIG. 13C, if the terminal screen is overlapped with the glass screen, in a state where content such as photos, videos and music files has been displayed on the glass screen and an SNS page has been displayed on the terminal screen, the content displayed on the glass screen is automatically uploaded to a user's SNS. The upload operation may be executed by the mobile terminal or the glass terminal.

Overlapping Between the Glass Screen being Uploaded and the Terminal Screen

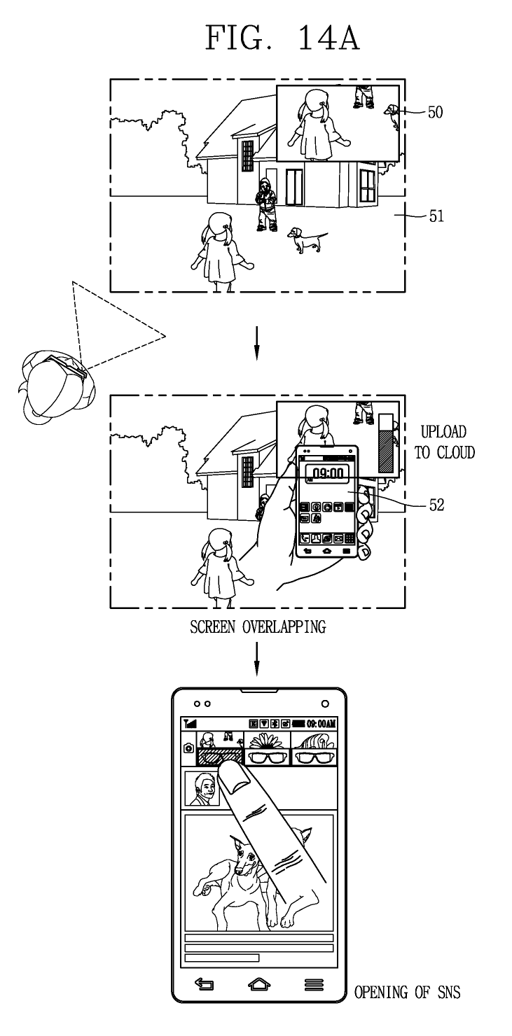

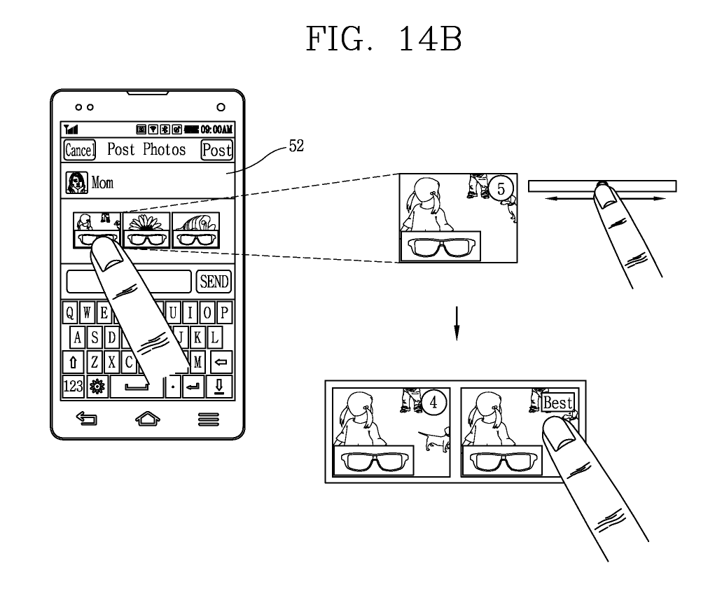

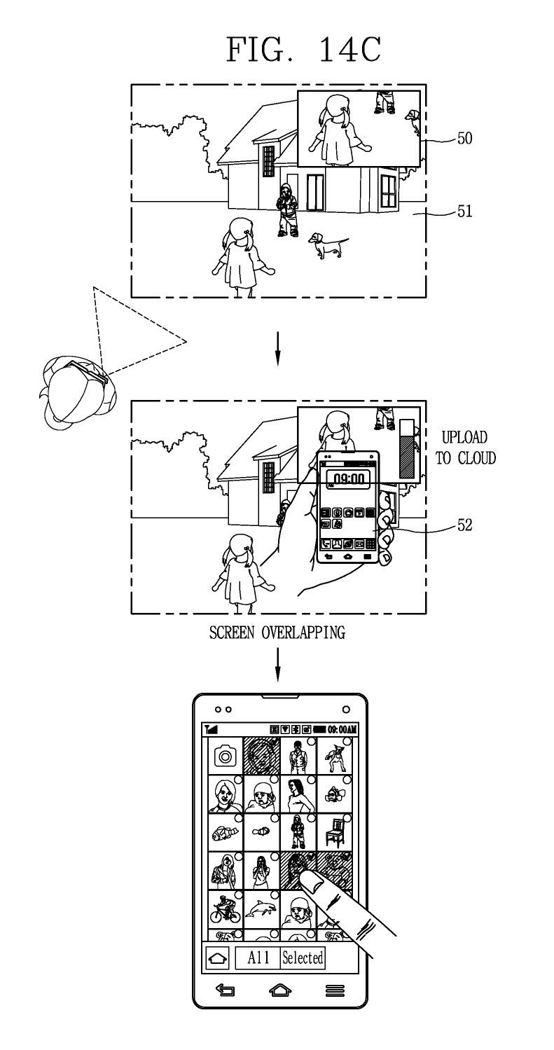

FIGS. 14A to 14D are views illustrating an embodiment to check an image captured to be uploaded by the glass terminal, using the mobile terminal by screen overlapping.

As shown in FIG. 14A, a photo captured by the camera of the glass terminal may be displayed on the glass screen, and may be automatically uploaded to an SNS (or cloud). While the captured image is uploaded to the SNS, if the terminal screen is overlapped with the glass screen, the controller 180 of the mobile terminal automatically opens an SNS page, and displays the image uploaded by the glass terminal on the SNS page. A user may check the photo captured by the glass terminal in a selective manner.

In another embodiment, if there are a plurality of photos uploaded to the SNS, photos captured at similar time points are displayed in the form of a group as shown in FIG. 14B. Once the photo group is unfolded by touch, a best shot is displayed on a finally-touched point or at the end of the group. Upon selection of a specific photo, the controller 180 may display a keypad for editing the uploaded photo (inputting a title and a memo).

In still another embodiment, a photo captured by the camera of the glass terminal may be displayed on a gallery of the mobile terminal, in a differentiated manner from a photo captured by the mobile terminal, as shown in FIG. 14C. A user may select a desired photo from photos captured by the camera of the glass terminal, and may delete the selected photo or upload the selected photo to an SNS.

In still another embodiment, while a photo captured by the glass terminal is uploaded to a cloud (or SNS), if the terminal screen is overlapped with the glass screen, a control screen is displayed on the terminal screen, the control screen for controlling photos captured by the glass terminal, photos captured by the mobile terminal, and the photo uploaded to the SNS, as shown in FIG. 14D. A user may select a photo from the control screen, and may directly upload the photo captured by the glass terminal to a cloud (or SNS) or may delete a specific photo from the cloud. Alternatively, the user may move a photo to an edition screen by double-touch, and then may edit the photo. In each embodiment, the user may select a photo from a screen overlapping menu.

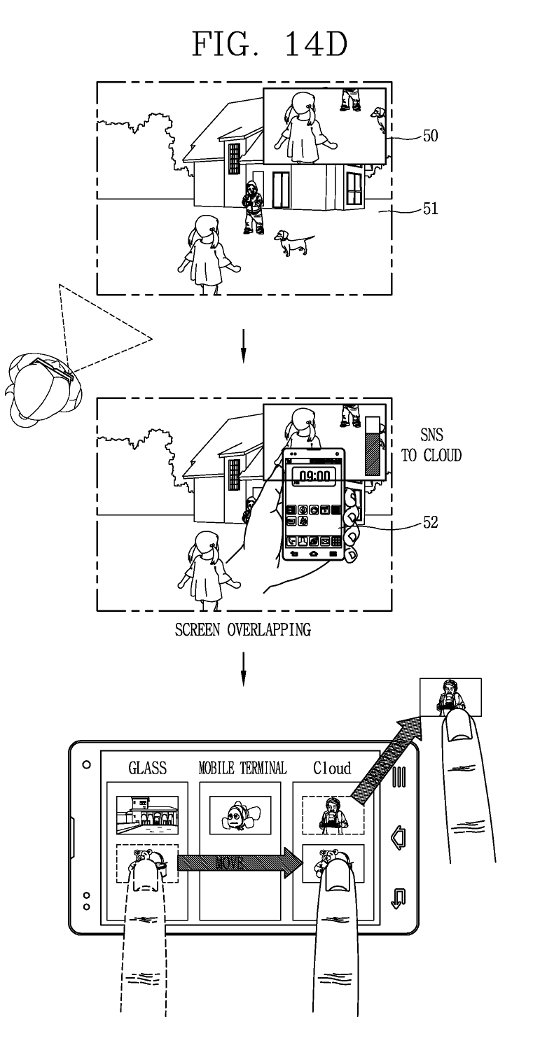

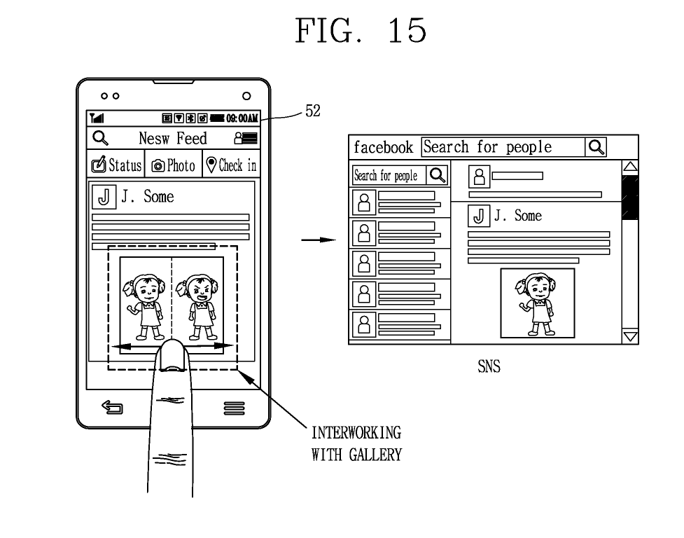

FIG. 15 is a view illustrating an embodiment to update a photo uploaded to an SNS by the glass terminal, through interworking with a gallery of the mobile terminal.

Generally, a user captures a plurality of photos using the glass terminal, and then uploads a best shot to an SNS. The plurality of photos captured by the glass terminal are transmitted to the mobile terminal, by the aforementioned screen overlapping, and then are stored in a gallery.

As shown in FIG. 15, once a user accesses the SNS where the best shot has been stored through the mobile terminal, the SNS is automatically interworked with the gallery of the mobile terminal. As a result, the plurality of photos stored in the gallery are displayed on an SNS photo region. Once the user selects for a new photo by touching the plurality of photos right and left, the best shot previously uploaded is automatically updated as a newly-selected photo.

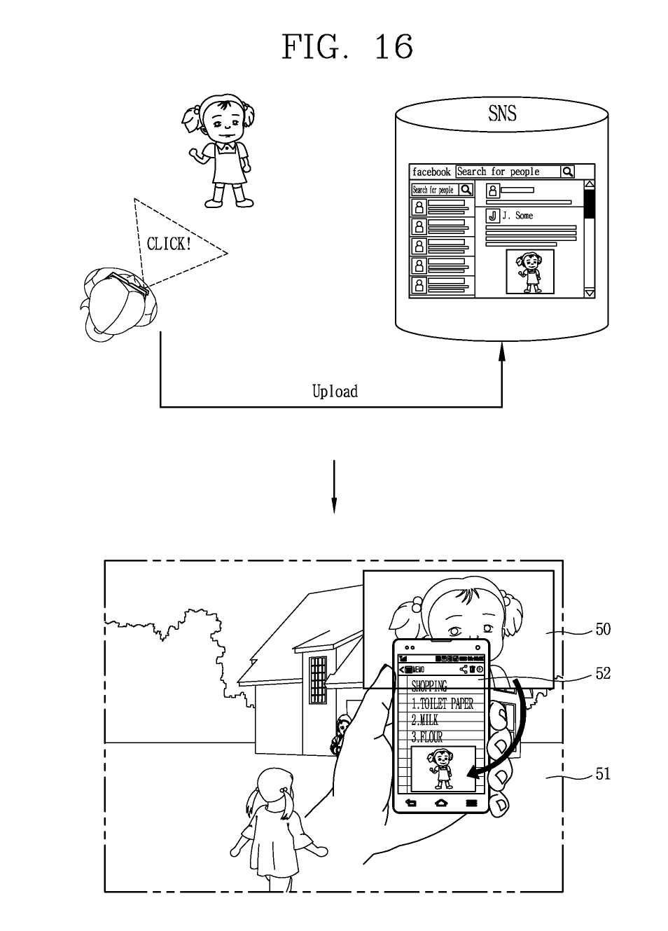

FIG. 16 is a view illustrating an embodiment to update a photo uploaded to an SNS by the glass terminal, by screen overlapping.

A photo captured by the glass terminal may be directly updated to an SNS. In case of changing the uploaded photo, a user captures a new photo using the glass terminal, displays the captured photo on the glass screen, and displays an SNS page where the previous photo has been uploaded on the terminal screen. In this state, if the terminal screen and the glass screen are overlapped with each other, the photo uploaded to the SNS is automatically updated as the new photo displayed on the glass screen.

Hereinafter, will be explained an embodiment to execute content sharing between the mobile terminal and the glass terminal, by screen overlapping through a touch and drag operation.

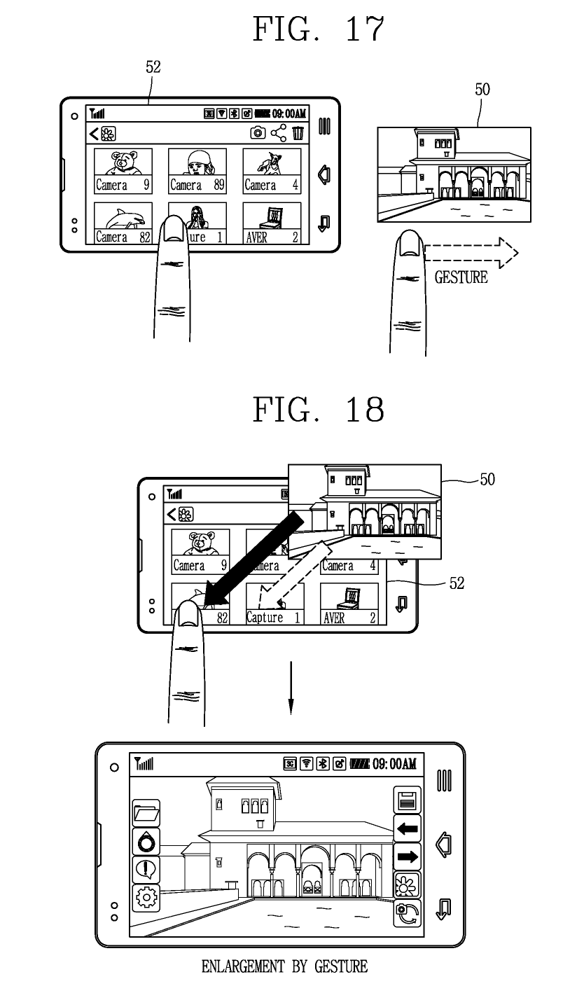

FIG. 17 is a view illustrating an embodiment to share content between the terminal screen and the glass screen by touch, in a screen sharing mode according to a second screen sharing.

As shown in FIG. 17, a user may use both the terminal screen and the glass screen, in a screen sharing mode according to a second screen sharing. When the terminal screen and the glass screen are not overlapped with each other, the terminal screen is controlled by touch, and the glass screen is controlled by gesture. That is, drag in right and left directions, content deletion, content transmission, etc. on the glass screen may be executed by gesture.

FIG. 18 is a view illustrating a first embodiment to transmit a photo displayed on the glass screen, to the mobile terminal, by touch in a screen sharing mode according to a second screen sharing.

As shown in FIG. 18, a gallery displayed on the terminal screen may be overlapped with a photo displayed on the glass screen in the form of a preview. Once a user touches the glass control region 53 (refer to FIG. 5B) where the terminal screen and the glass screen are overlapped with each other to drag only to the terminal screen, a photo being currently displayed on the glass terminal is transmitted to the gallery of the mobile terminal.

If a user executes a drag operation from the glass terminal to the mobile terminal by gesture in the air, a photo displayed on the glass screen is enlarged to be displayed on the terminal screen in the form of a preview. The user edits the photo displayed on the terminal screen, and the edited photo is stored in a memory of the glass terminal.

Upon completion of the photo edition, the gallery is displayed on the terminal screen, and the edited photo is displayed on the glass screen.

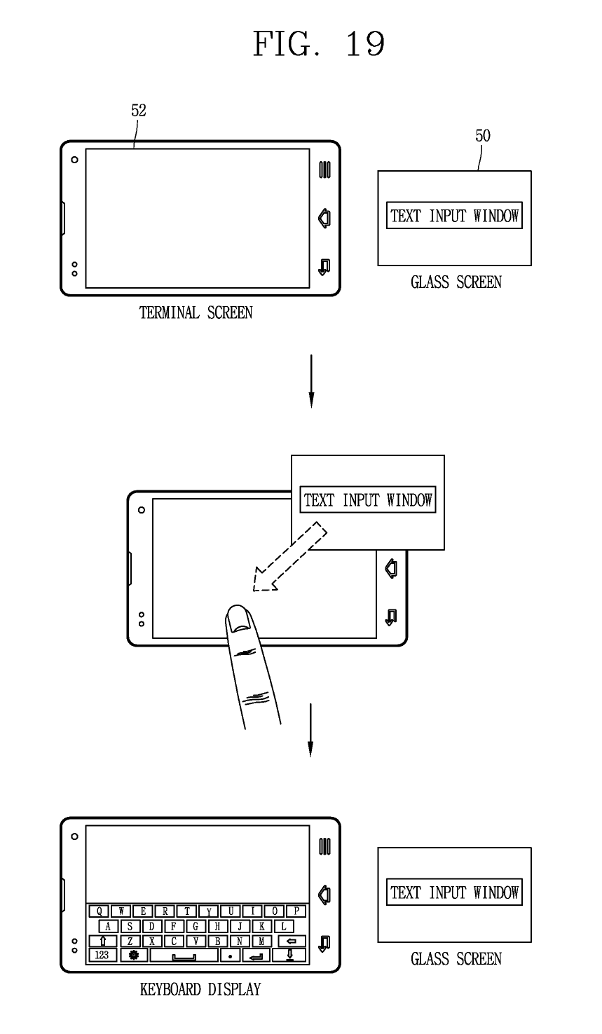

FIG. 19 is a view illustrating a embodiment to perform an interworking between the mobile terminal and the glass terminal by touch in a screen sharing mode according to a second screen sharing.

As shown in FIG. 19, in a state where a text input window has been displayed on the glass screen, the text input window may be overlapped with the terminal screen. In this state, if a user drags the text input window to the mobile terminal by gesture in the air, a keyboard may be displayed on the terminal screen. In this case, the text input window may be displayed on the terminal screen together with the keyboard.

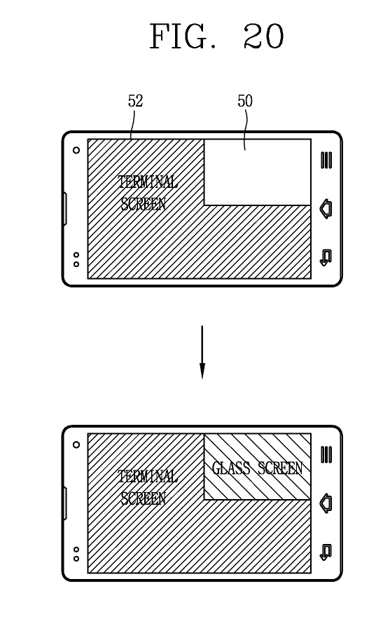

FIG. 20 is a view illustrating an embodiment to control transparency of the glass screen during screen overlapping, in a screen sharing mode according to a second screen sharing.

If the glass screen and the terminal screen are overlapped with each other, the glass screen is not visible due to light of the terminal screen. Especially, the glass screen is not visible when an object which emits light spontaneously is overlapped therewith. In order to solve such a problem, as shown in FIG. 20 of the present invention, when the glass screen is overlapped with the terminal screen (or notebook screen) where light exists, the controller automatically controls the glass screen to be semi-transparent or opaque. That is, transparency of the glass screen is automatically controlled according to a brightness of the terminal screen.

Generally, a user should be careful not to expose his or her privacy to a third party, when manipulating the mobile terminal at a public place, e.g., when sending a text message.

The present invention provides a method for protecting a user's privacy through interworking between the mobile terminal and the glass terminal.

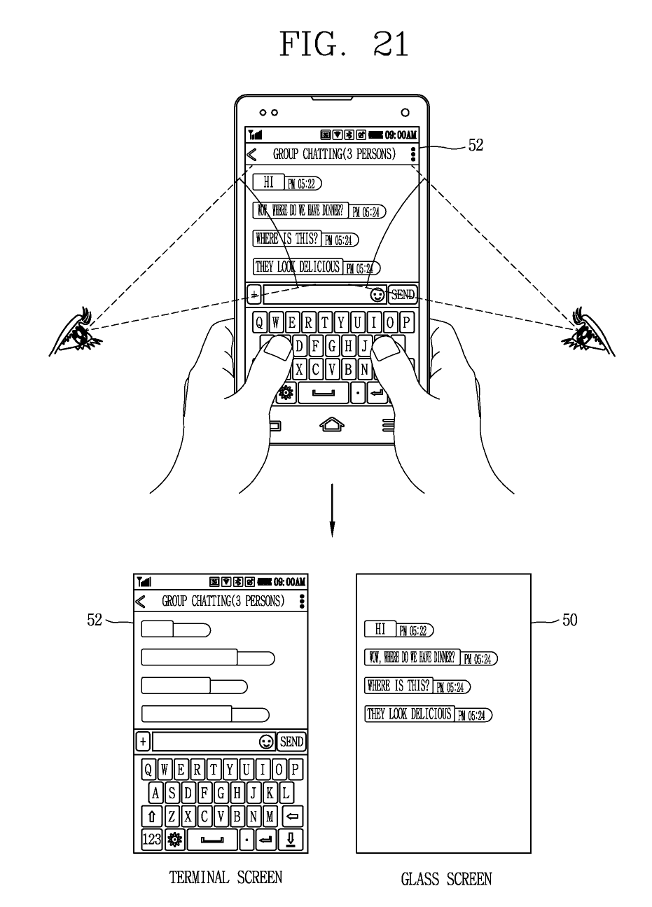

FIG. 21 is a view illustrating a method for protecting a user's privacy in a screen sharing mode according to the present invention. The screen sharing mode means a second screen sharing.

As shown in FIG. 21, when more than a predetermined size of the terminal screen is recognized by the glass camera (screen overlapping), the controller 180 may display a pop-up inquiring whether to set a screen sharing mode or not, as aforementioned. If a screen sharing mode is set (or has been set) on the pop-up, a privacy mode is automatically set according to a type of content displayed on the terminal screen (message, kakao talk, SNS, Email or E-book).

Once the privacy mode is set, texts are input through the keyboard of the mobile terminal, and a user's privacy content substantially input, such as texts and photos, are displayed on the glass screen. Thus, the user's privacy content displayed on the glass screen is displayed on a layout of the terminal screen, in a synchronized (overlapped) manner. This can allow the user to write messages without being conscious of others.

Generally, a user has a difficulty in entering a plurality of UI depths by selecting for a plurality of menus, in order to search for desired information (e.g., additional information) in the mobile terminal.

The present invention provides a method for conveniently searching for information through interworking between the mobile terminal and the glass terminal.

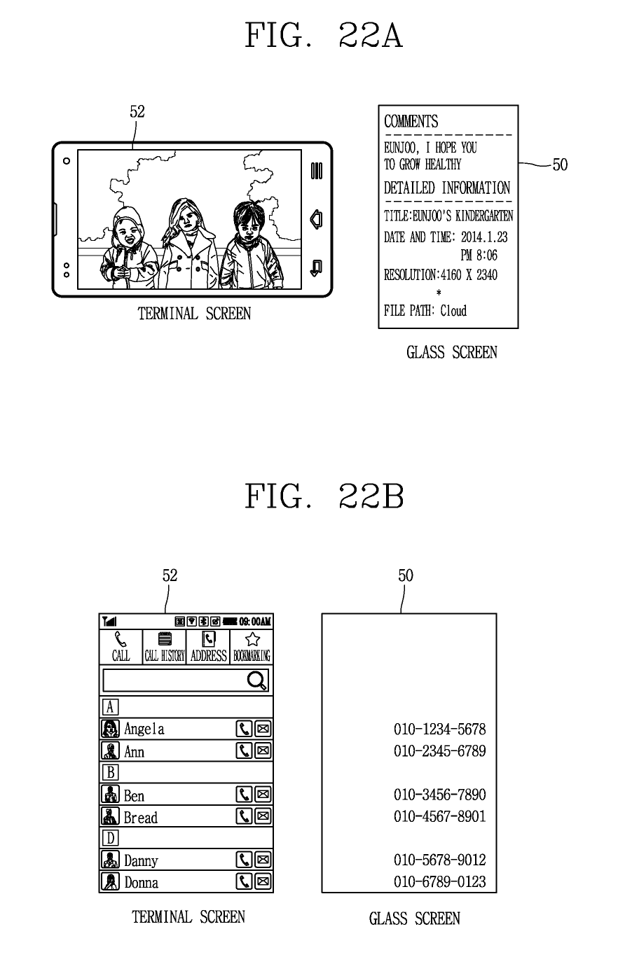

FIGS. 22A and 22B are views illustrating an embodiment to search for information in a screen sharing mode according to the present invention. The screen sharing mode means a second screen sharing.

As shown in FIG. 22A, once a user stares at a photo displayed on the mobile terminal for a predetermined time, the controller 180 checks whether a screen sharing mode has been set. If the screen sharing mode has been set, the controller 180 shares information with the glass terminal. Thus, the photo is displayed on the terminal screen, and information of depth 1 or less (comments, a title, and detailed information) is displayed on the glass screen. For this, the controller of the mobile terminal may sense a user's eyeline.

As shown in FIG. 22B, once a user stares at a specific name included in an address book displayed on the mobile screen, the controller 180 of the mobile terminal displays information on phone numbers of depth 1 or less, on the glass screen, in the same manner as in FIG. 22A. In this case, the phone numbers displayed on the glass screen are displayed on a layout of the address book, in an overlapped manner.

Generally, a locked state of the mobile terminal may be exposed to other person, since it is fixed. To solve such a problem, it is required to set a locked state releasing pattern for setting and releasing a locked state more easily without being exposed to other person.

The present invention provides a method for conveniently setting a locked state releasing pattern through interworking between the mobile terminal and the glass terminal.

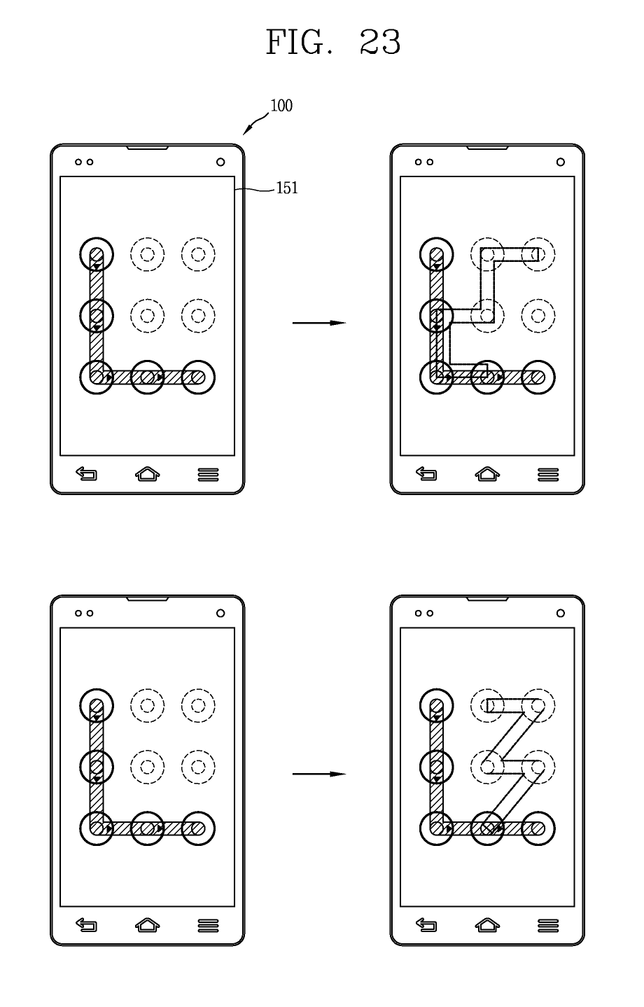

FIG. 23 is a view illustrating an embodiment to release a locked state in a screen sharing mode according to the present invention. The screen sharing mode means a second screen sharing.

In the present invention, two methods for releasing a locked state may be used.

The first method is a basic method for releasing a locked state using a pattern set by a user, in a visible manner (guest mode). In case of using the first method, private information (an e-mail, an SNS, a call history, and an address book) is in a locked state.

The second method is a virtual locking method for generating a new pattern on the glass screen at random whenever a user turns on the terminal screen (personal mode). As shown in FIG. 23, if a user who is wearing the glass terminal views the terminal screen, a new pattern is generated to be displayed on the terminal screen in an overlapped manner.

Once the virtual locked state is released, the user may check information such as an email, an SNS, a call history and an address book, through a log-in process.

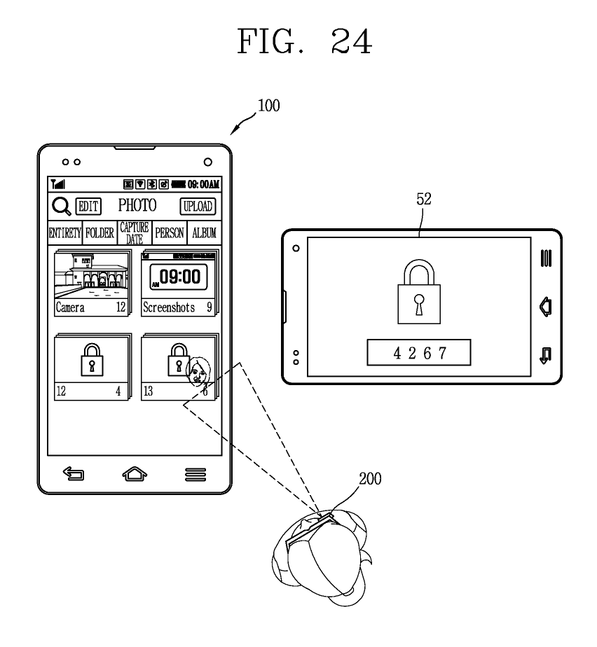

FIG. 24 is a view illustrating an embodiment to release a locked state of content in a screen sharing mode according to the present invention. The screen sharing mode means a second screen sharing.

Referring to FIG. 24, a photo or a moving image included in the gallery displayed on the terminal screen may be set to be in a locked state. Once the gallery is displayed, content set to be in a locked state is displayed in a distinguished manner. Once a user who is wearing the glass terminal views the content set to be in a locked state (screen overlapping), the content set to be in a locked state may be overlapped with the gallery. As a result, the content having the locked state released may be displayed on the glass screen, or a temporary password may be displayed on the content.

As aforementioned, in the present invention, a user can visually check a state of content in transmission, deletion and upload, as the mobile terminal and the glass terminal share their screens. Further, the user's privacy can be protected more safely, with respect to content displayed on the user's mobile terminal.

Various embodiments may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The processor may include the controller 180 of the mobile terminal.

The foregoing embodiments and advantages are merely exemplary and are not to be considered as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A method for controlling a mobile terminal configured to communicate with a wearable terminal, the method comprising:
recognizing overlapping of a first screen of the mobile terminal and a second screen of the wearable terminal that are within a camera region of the wearable terminal; and
causing a change of information displayed on the first screen based on a function being executed and displayed on the second screen in response to the recognized overlapping.

2. The method of claim 1, further comprising:
displaying, on the first screen, a pop-up menu for setting a screen sharing mode that allows sharing information between the mobile terminal and the wearable terminal when the first screen is determined to enter the camera region,
wherein:
the sharing mode comprises a first mode and a second mode;
when the screen sharing mode is set as the first mode, the first screen is active and the second screen is inactive; and
when the screen sharing mode set as the second mode, both the first screen and the second screen are active.

3. The method of claim 2, further comprising:
dividing the first screen into a first control region and a second control region in the first mode of the screen sharing mode;
displaying a screen corresponding to the first screen on the first control region, and displaying a screen corresponding to the second screen on the second control region; and
executing transmission of content between the mobile terminal and the wearable terminal or executing deletion of the content according to a touch input applied via at least the first control region or the second control region.

4. The method of claim 3, further comprising adjusting sizes of the first control region and the second control region in response to an input received via an indicator in a first or second direction such that a size of the first control region becomes greater when the input is received in the first direction, and a size of the second control region becomes greater when the input is received in the second direction,
wherein the indicator is provided between the first control region and the second control region.

5. The method of claim 2, further comprising controlling transparency of the second screen according to a brightness of the first screen when the first screen and the second screen are overlapped in the second mode of the screen sharing mode.

6. The method of claim 2, further comprising controlling a setting value of the wearable terminal in response to a key input received via the mobile terminal while the first screen and the second screen that is in a standby state are overlapped in the second mode of the screen sharing mode,
wherein the setting value includes a volume and a screen brightness.

7. The method of claim 1, further comprising:
registering a key of the mobile terminal as a shutter button for capturing an image included in a camera preview displayed on the second screen in response to the overlapping recognized while the camera preview is displayed on the second screen and while the key of the mobile terminal is pressed; and
capturing the image in response to a input received via the key.

8. The method of claim 1, further comprising:
transmitting first content displayed on the first screen from the mobile terminal to the wearable terminal when the first screen and the second screen are overlapped for more than a reference time; and
transmitting second content displayed on the second screen from the wearable terminal to the mobile terminal when the first screen and the second screen are overlapped for less than the reference time.

9. The method of claim 1, wherein when the overlapping of the first screen and the second screen is recognized while an image captured by the wearable terminal is uploaded to a cloud or an social networking service (SNS), the method further comprises displaying, on the first screen, a page of the cloud or SNS to which the image is uploaded.

10. The method of claim 1, further comprising:
setting a privacy mode according to a type of content displayed on the first screen when the overlapping is recognized; and
causing displaying of information that is received via an input unit of the mobile terminal on the second screen according to the set privacy mode such that the content including the information is no longer displayed on the first screen in the privacy mode,
wherein a type of the content includes at least a message, a social networking service (SNS) page, an Email, or an E-book.

11. The method of claim 1, further comprising causing displaying, on the second screen, of detailed information of content displayed on the first screen in response to the recognized overlapping,
wherein the detailed information is displayed in an overlapped manner with a layout of the content on the first screen.

12. A mobile terminal, comprising:
a communication unit configured to communicate with a wearable terminal;
a display configured to display a first screen; and
a controller configured to:
recognize overlapping of the first screen and a second screen of the wearable terminal that are within a camera region of the wearable terminal; and
cause a change of information displayed on the first screen based on a function being executed and displayed on the second screen in response to the recognized overlapping.

13. The mobile terminal of claim 12, wherein the controller is further configured to cause the display to display a pop-up menu for setting a screen sharing mode that allows sharing information between the mobile terminal and the wearable terminal when the first screen is determined to enter the camera region,
wherein:
the sharing mode comprises a first mode and a second mode;
when the screen sharing mode is set as the first mode, the first screen is active and the second screen is inactive; and
when the screen sharing mode set as the second mode, both the first screen and the second screen are active.

14. The mobile terminal of claim 13, wherein the controller is further configured to:
cause division of the first screen on the display into a first control region and a second control region in the first mode of the screen sharing mode;
cause the display to display a screen corresponding to the first screen on the first control region, and to display a screen corresponding to the second screen on the second control region; and
execute transmission of content between the mobile terminal and the wearable terminal or execute deletion of the content according to a touch input applied via at least the first control region or the second control region.

15. The mobile terminal of claim 14, wherein the controller is further configured to adjust sizes of the first control region and the second control region in response to an input received via an indicator in a first or second direction such that a size of the first control region becomes greater when the input is received in the first direction, and a size of the second control region becomes greater when the input is received in the second direction,
wherein the indicator is provided between the first control region and the second control region.

16. The mobile terminal of claim 13, wherein the controller is further configured to control transparency of the second screen according to a brightness of the first screen when the first screen and the second screen are overlapped in the second mode of the screen sharing mode.

17. The mobile terminal of claim 13, wherein the controller is further configured to control a setting value of the wearable terminal in response to a key input received via the mobile terminal while the first screen and the second screen that is in a standby state are overlapped in the second mode of the screen sharing mode,
wherein the setting value includes a volume and a screen brightness.

18. The mobile terminal of claim 12, wherein the controller is further configured to:
register a key of the mobile terminal as a shutter button for capturing an image included in a camera preview displayed on the second screen in response to the overlapping recognized while the camera preview is displayed on the second screen and while the key of the mobile terminal is pressed; and
cause capturing of the image in response to a input received via the key.

19. The mobile terminal of claim 12, wherein the controller is further configured to cause the communication unit to:
transmit first content displayed on the first screen from the mobile terminal to the wearable terminal when the first screen and the second screen are overlapped for more than a reference time; and
transmit second content displayed on the second screen from the wearable terminal to the mobile terminal when the first screen and the second screen are overlapped for less than the reference time.

20. The mobile terminal of claim 12, wherein when the overlapping of the first screen and the second screen is recognized while an image captured by the wearable terminal is uploaded to a cloud or an social networking service (SNS), the controller is further configured to cause the display to display, on the first screen, a page of the cloud or SNS to which the image is uploaded.

21. The mobile terminal of claim 12, wherein the controller is further configured to:
set a privacy mode according to a type of content displayed on the first screen when the overlapping is recognized; and
cause displaying of information that is received via an input unit of the mobile terminal on the second screen according to the set privacy mode such that the content including the information is no longer displayed on the first screen in the privacy mode,
wherein a type of the content includes at least a message, a social networking service (SNS) page, an Email, or an E-book.

22. The mobile terminal of claim 12, wherein the controller is further configured to cause displaying, on the second screen, of detailed information of content displayed on the first screen in response to the recognized overlapping,
wherein the detailed information is displayed in an overlapped manner with a layout of the content on the first screen.
